(19) United States
(12) Patent Application Publication
(10) Pub. No.: US 2013/0210992 A1
(43) Pub. Date: Aug. 15, 2013

(54) METHOD OF PREPARING PIGMENT DISPERSIONS

(71) Applicants: Michael Joseph Otley, Hockessin, DE (US); Michael Stephen Wolfe, Wilmington, DE (US)

(72) Inventors: Michael Joseph Otley, Hockessin, DE (US); Michael Stephen Wolfe, Wilmington, DE (US)

(73) Assignee: E I DU PONT DE NEMOURS AND COMPANY, Wilmington, DE (US)

(21) Appl. No.: 13/882,288

(22) PCT Filed: Dec. 15, 2011
(86) PCT No.: PCT/US11/65084

§ 371 Date: Apr. 29, 2013

Related U.S. Application Data
(60) Provisional application No. 61/423,239, filed on Dec. 15, 2010.

(51) Int. Cl. C08L 33/08

(52) U.S. Cl. CPC C08L 33/08
USPC 524/558; 524/561; 524/591

(57) ABSTRACT

A process for preparing pigment dispersions is provided in which an organic solvent is used during the milling process in the preparation of pigment dispersions containing a water-soluble polymer as a dispersant.

### CROSS REFERENCE TO RELATED APPLICATIONS

This application claims priority under 35 U.S.C. §119 from U.S. Provisional Application Ser. No. 61/423239, filed Dec. 15, 2010 which is incorporated by reference in its entire.

### BACKGROUND OF THE DISCLOSURE

This disclosure relates to process of making pigment dispersions containing a water-soluble polymer as a dispersant by using an organic solvent during the milling process.

Aqueous dispersions of pigments are widely used in ink-jet printing. Because a pigment is typically not soluble in an aqueous vehicle, a dispersing agent is often required, such as a polymeric dispersant or a surfactant, to produce a stable dispersion of the pigment in the aqueous vehicle.

Conventional dispersants are adsorbed onto the surface of the particulate solid by physical interactions, Many conventional dispersants suffer from a disadvantage in that they may readily be displaced from the surface of the particulate solid by a more strongly adsorbing or displacing material resulting in destabilization and consequently flocculation of the dispersion.

Various dispersion processes are known, A two-roll process of dispersing pigments using polymeric dispersants is disclosed in U.S. Pat. No. 5,310,778. A process where a combination of solvents is used and a polymeric dispersant is precipitated from the solvent mixture onto the finely dispersed pigment particles is disclosed in U.S. Pat. No. 6,924,035. A process where the organic solvent is removed from a mixture of an organic solvent solution of a polymer and water, followed by subjecting the solvent-removed product to a dispersion treatment while a pigment is added, is disclosed in U.S. Pat. No. 6,723,785.

A need exists for an easy-to-operate, more effective, and lower cost process for making stable colorant dispersions, especially dispersions for high performance ink-jet ink applications, The present disclosure satisfies this need by providing a process for making a colorant dispersion by using an organic solvent duriniz the milling process of a pigment and a water-soluble polymer as a dispersant, followed by removal of the organic solvent, to produce pigment dispersions with increased amount of polymer bound to the pigment surface. These dispersions demonstrate improved jetting upon applied in ink-jet inks, and improved print durability for smear and smudge resistance when printed on paper.

### SUMMARY OF THE DISCLOSURE

An embodiment of the disclosure provides a process for making an aqueous pigment dispersion comprising the steps of:
a) preparing an initial mixture comprising water, a pigment, an organic solvent and a water-soluble polymer as a dispersant to disperse said pigment, wherein the water-soluble polymer has a solubility of greater than 10 grams per 100 grams of water at 25°C., and the organic solvent is selected from the group consisting of methyl ethyl ketone, acetone, diethyl ketone, methyl isobutyl ketone, ethanol, isopropanol, dibutyl ether, tetrahydrofuran, and mixture thereof;
b) subjecting the initial mixture to a dispersive mixing operation;
c) milling to reduce particle size; and
d) removing the organic solvent

Another embodiment provides that the water-soluble polymer contains a salt-forming group.

Another embodiment provides that the salt forming group is one or more members selected from the group consisting of —OH, —SH, —COOH, —COOH, —OPO₃H₂, —PO₃H₂, —SO₃H, —NR¹R², and mixture thereof, wherein each R¹ and R² are independently H, C₁-C₂₀ alkyl or C₇-C₂₀ aralkyl.

Another embodiment provides that the water-soluble polymer is an acrylic polymer.

Another embodiment provides that the water-soluble polymer is a polyurethane.

Another embodiment provides that the process further comprising a step of purifying the dispersion by ultrafiltration after step (c) or step (d).

Another embodiment provides that step (d) comprises distillation to remove the organic solvent.

Another embodiment provides that step (d) comprises ultrafiltration to remove the) organic solvent.

Another embodiment provides that the organic solvent is methyl ethyl ketone.

Another embodiment provides that the organic solvent is isopropanol.

Another embodiment provides that the organic solvent is dibutyl ether.

Another embodiment provides that the degree of neutralization is in the range of 50% to 100%.

Another embodiment provides that the degree of neutralization is in the range of 70% to 95%.

Another embodiment provides that the ratio of pigment to water soluble polymer is from 10:1 to 1:1.

Another embodiment provides that the ratio of pigment to water soluble polymer is from 8:1 to 1:1.

Another embodiment provides that the average particle size after step (c) is between 0.005 microns and 5 microns.

Yet another embodiment provides that the average particle size after step (c) is between 0.01 microns and 0.3 microns.

These and other features and advantages of the present embodiments will be more readily understood by those of ordinary skill in the art from a reading of the following Detailed Description. Certain features of the disclosed embodiments which are, for clarity, described above and below as a separate embodiment, may also be provided, in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood, as specifically disclosing all ranges formed from any pair of any upper range limit or preferred value and any lower range limit or preferred value, regardless of whether ranges are separately disclosed, Where a range of numerical values is recited herein, unless otherwise stated, the range is intended to include the endpoints thereof, and. all integers and fractions within the range.

When the term “about” is used in describing a value or an end-point of a range, the disclosure should be understood to include the specific value or end-point referred to

As used herein, “comprising” is to be interpreted as specifying the presence of the stated features, integers, steps, or components as referred. to, but does not preclude the presence or addition of one or more features, integers, steps, or components, or groups thereof. Additionally, the term “comprising” is intended to include examples encompassed by the terms “consisting essentially of” and “consisting of” Similarly, the term “consisting essentially of” is intended to include examples encompassed by the term “consisting of.”

As used herein, the dispersions produced with the dispersant polymer described above can be utilized to disperse particles, especially pigments for ink-jet inks, These inks can be printed on all normally used ink-jet substrates including plain paper, photo paper, paper for network and commercial printing, and textile substrates.

As used herein, the term “dispersion” means a two phase system where one phase consists of finely divided particles (often in the colloidal size range) distributed throughout a bulk substance, of the particles being the dispersed or internal phase and the bulk substance being the continuous or external phase.

As used herein, the term “dispersant” means a surface active agent added to a suspending medium to promote uniform and maximum separation of extremely fine solid particles often of colloidal size. For pigments, dispersants are most often polymeric dispersants.

As used herein, the term “P/D” means the ratio between a pigment and a dispersant.

As used herein, the term “aqueous vehicle” refers to water or a mixture of water and at least one water-soluble, or partially water-soluble (i.e. methyl ethyl ketone), organic solvent (co-solvent).

As used herein, the term “Mw” means weight average molecular weight.

As used herein, the term “Mn” means number average molecular weight.

As used herein, the term “neutralizing agents” includes all types of agents that are useful for converting ionizable groups to the more hydrophilic ionic (salt) group.

As used herein, the term “degree of neutralization” means the mole percentage of acidic or basic components on the dispersant polymer that is neutralized by a neutralizing) agent.

As used herein, the term “D50” means the volume particle diameter of the 50th percentile (median) of the distribution of particle sizes.

As used herein, the term ‘D95’ means the volume particle diameter of the 95th percentile of the distribution of particle sizes.

As used herein, the term “cPs” means centipoise, a viscosity unit.

As used herein, the term “mN·m⁻¹” means milliNewtons per meter, a surface tension unit.

As used herein, the term “mPa·s” means millipascal second, a viscosity unit.

As used herein, the term “AN” means acid number, mg KOH/gram of solid polymer.

As used herein, the term “HSD” means High Speed Dispersing.

As used herein, the term “GPC” means gel permeation chromatography.

As used herein, the term “BZMA” means benzyl methacrylate.

As used herein, the term “ETEGMA” means ethoxytriethylene glycol methacrylate.

As used herein, the term “MAA” means methacrylate.

As used herein, the term “ETEGMA/BZMA//MAA” means the block copolymer of ETEGMA, BZMA and MAA.

As used herein, the term “THF” means tetrahydrofuran.

As used herein, the term “Sulfolane” means tetramethylene sulfone.

As used herein, the term “BMA” means butyl methacrylate acid.

As used herein. Nipex® 180 is a black pigment from Degussa, Germany.

As used herein, the term “PMMA” means polymethylmethacrylate.

As used herein, the term “EDTA” means ethylenediaminetetraacetic acid.

As used herein, the term “IDA” means iminodiacetic acid.

As used herein, the term “EDDHA” means ethylenediamine-di(o-hydroxyphenylacetic acid.

As used herein, the term “NTA” means nitrilotriacetic acid.

As used herein, the term “DHEG” means dihydroxyethylalycine.

As used herein, the term “CyDTA” means trans-1,2-cyciohexanediaminetetraacetic acid.

As used herein, the term “DTPA” means dethylenetriaminc-N,N,N′,N″,N″-pentaacetic acid.

As used herein, the term “GEDTA” means glycoletherdiamine-N,N,N′,N′-tetraacetic acid.

As used herein, the term “GPC” means Gel Permeation Chromatography.

As used herein, the term “aralkyl” denotes aryl substitution on an alkyl moiety. Examples of “aralkyl” include benzyl, diphenylmethyl, p-methylbenzyl and other aryl moieties bonded to straight-chain or branched alkyl groups.

Unless otherwise noted, the above chemicals were obtained from Aldrich (Milwaukee, Wis.) or other similar suppliers of laboratory chemicals.

In addition, references in the singular may also include the plural (for example, “a” and “an” may refer to one, or one or more) unless the context specifically states otherwise.

One embodiment of the present disclosure provides a process for making an aqueous pigment dispersion comprising the steps of:
a) preparing an initial mixture comprising water, a pigment, an organic solvent and a water-soluble polymer as a dispersant to disperse said pigment, wherein said water-soluble polymer has a solubility of greater than 10 grams per 100 grams of water at 25° C., and said organic solvent is selected from the group consisting of methyl ethyl ketone, acetone, diethyl ketone, methyl isobutyl ketone, ethanol, isopropanol, dibutyl ether, tetrahydrofuran, and. mixture thereof;
b) subjecting the initial mixture to a dispersive mixing operation;
c) milling to reduce particle size; and
d) removing said organic solvent.

The water-soluble polymer in Step (a) is a random or structured polymer having a solubility of greater than 10 grams per 100 grams of water at 25° C. The term “random polymer” means polymers where molecules of each monomer are randomly arranged in the polymer backbone. For a reference on suitable random polymeric dispersants, see: U.S. Pat. No. 4,597,794. The term “structured polymer” means polymers having a block, branched or graft structure, Examples of structured polymers include AB or BAB block copolymers as disclosed in U.S. Pat. No. 5,085,698; ABC block copolymers as disclosed in EP Patent Specification 0556649; and graft copolymer. The graft copolymer typically has a weight average molecular weight of from about 4,000 to about 100,000, and more typically from about 10,000 to about 40,000. Mixtures of more than one graft copolymer can also be used. The graft copolymer comprises from about 90% to about 50% by weight of a polymeric backbone and, correspondingly, from about 10% to about 50% by weight of polymeric side chains (arms) attached to the backbone. Typically, the polymeric backbone is a hydrophobic (relative to the side chains) adsorbing segment, and the side chains contain hydrophilic stabilizing macromonomers from the polymerization of ethylenically unsaturated “hydrophilic” monomers, such as ethylenically unsaturated monomers containing an acid group or a nonionic hydrophilic group. Alternatively, the polymeric backbone can be hydrophilic and the side chains hydrophobic. The side chains are attached to the backbone at a single terminal point. For a leading reference on graft copolymers, see: U.S. Pat. No. 5,231,131.

The water-soluble polymeric dispersant suitable for use in the present disclosure generally comprise both hydrophobic and hydrophilic monomers. Some examples of hydrophobic monomers used in random polymers are methyl methacrylate, n-butyl methacrylate, 2-ethylhexyl methacrylate, benzyl methacrylate, 2-phenylethyl methacrylate and the corresponding acrylates. Some examples of hydrophilic monomers are methacrylic acid, acrylic acid, dimethylaminoethyl(meth)acrylate, and salts thereof.

Other polymeric dispersants that can be used are described, for example, in U.S. Pat. Nos. 6,117,921; 6,262,152; 6,306,994 and 6,433,117.

### Pigments

A wide variety of organic and inorganic pigments, alone or in combination, may be dispersed with the polyurethane dispersant to prepare an ink, especially an ink- jet ink. The term “pigment” as used herein means an insoluble colorant that requires to be dispersed with a dispersant and processed under dispersive conditions in the presence of a dispersant. The dispersion process results in a stable dispersed pigment. The pigment used with the inventive polyurethane dispersants does not include self-dispersed pigments. The pigment particles are sufficiently small to permit free flow of the ink through the ink-jet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss, The range of useful particle size is typically about 0.005 micron to about 15 micron. Typically, the pigment particle size should range from about 0.005 to about 5 micron and, most typically, from about 0.005 to about 1 micron. The average particle size as measured by dynamic light scattering is less than about 500 nm, typically less than about 300 nm.

The selected pigment(s) may be used in dry or wet form. For example, pigments are usually manufactured in aqueous media, and the resulting pigments are obtained as a water-wet presscake, In presscake form, the pigment does not agglomerate to the extent like it is in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in inkjet inks include: cyan pigments from Pigment Blue 15:3 and Pigment Blue 15:4; magenta pigments from Pigment Red 122 and Pigment Red 202; yellow pigments from Pigment Yellow 14, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; green pigments from Pigment Green 1, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; white pigments such as TiO₂ and ZnO; and black pigment carbon black, The pigment names and abbreviations used herein are the “C.I.” designation for pigments established by Society of Dyers and Colourists, Bradford, Yorkshire, UK and published in The Color Index, Third Edition, 1971.

In the case of organic pigments, the ink may contain up to approximately 30%, typically from 0.1% to about 25% and more specifically from 0.25% to 10% of pigment, by weight based on the total weight. if an inorganic pigment is selected, the ink will tend to contain higher percentages by weight of pigment than with comparable inks employing organic pigment, since inorganic pigments generally have higher densities than organic pigments.

The ratio of the pigment to the water-soluble polymer is typically from 10:1 to 1:1. More typically, the ratio of the pigment to the water-soluble polymer is from 8:1 to 1:1.

A variety of organic solvents can be used in step (a). Typical organic solvents include alcohols such as ethanol and isopropanol; ketones such as acetone, methyl ethyl ketone, diethyl ketone and methyl isobutyl ketone; and ethers such as dibutyl ether and tetrahydrofuran.

In step (b), the initial mixture from step (a) is subjected to a dispersive mixing operation, This is generally done in a stirred mixing vessel, and a high-speed disperser (HSD) is particularly Klitable. A Cowels type blade attached to the HSD and operated at a speed from 500 rpm to 1000 rpm, and more typically from 2000 rpm to 3500 rpm, provides optimal shear to achieve the desired. mixing. Adequate mixing is usually achieved after mixing under the conditions described above a period of from 15 to 120 minutes.

In step (c), the product of step (b) was subjected to a milling/grinding operation. Typically, a media milling process is utilized, although other milling techniques can also be used. In the present embodiments, a lab-scale Eiger Minimill (Model M250, VSE EXP) manufactured by Eiger Machinery Inc., Chicago, Ill. is employed. Grinding was accomplished by charging about 820 grams of 0.5 YTZ® zirconia media to the mill. The mill disk is operated at a speed between 2000 rpm and 4000 rpm, and typically between 3000 rpm and 3500 rpm. The dispersion is processed using a re-circulation grinding process with a typical flow rate through the mill at between 200 to 500 grams/minute, and more typically at 300 grams/minute. Typically, the dispersions of the present embodiments are subjected to a total of 4 hours of milling.

For black dispersions, an alternate milling process using a Microfluidizer can be used. Mierofluidization is a non-media milling process in which milling is done by pigment impingement through nozzles under high pressures. Typically, pigment dispersions are processed at 15,000 psi with a flow rate of 400 grams/minute for a total of 12 passes through the mill.

Typically, the average particle size after step (e) is between 0.005 microns and 5 microns. More typically, the average particle size after step (c) is between 0.01 microns and 0.3 microns.

In step (d), the organic solvent is removed to form a pigment dispersion. The removal of the organic solvent can be accomplished by many means. Typically, the organic solvent is removed by a distillation or an ultrafiltration.

In another embodiment, the water-soluble polymer can contain a salt forming group. Typical salt forming groups include —OH, —SH, —COOH, —OPO₃H₂, —PO₃H₂, —SO₃H and amino groups. These salt forming groups are partially neutralized before the dispersant polymer is used to disperse a colorant. The purpose for this partial neutralization is to obtain an optimal balance of hydrophilicity and hydrophobicity for the dispersant polymer thus allowing it to be adsorbed onto the surface of the pigment while minimizing the level of un-adsorbed dispersant polymer. Typically, the degree of neutralization is from 50% to 100%, and more typically from 70% to 95%, depending on the acid number of the dispersant polymer. Often the higher the acid number of the dispersant polymer, the lower the degree of neutralization can be done without causing the dispersant polymer to be overly hydrophobic. More typically, the degree of neutralization is adjusted so as the remaininglin-adsorbed dispersant polymer is less than 20% of the colorant concentration.

The neutralizing agent employed to accomplish the partial neutralization described above can be hydroxides of alkali metals, amines and the like, or acids in the case that the salt forming group is an amino group. Examples of neutralizing agents include organic bases such as mono-, di-, or tri-methylamine, morpholine, n-methyl morpholine, alcohol amines such as dimethylethanolamine (DMEA), aminomethylpropanol and methyldiethanolamine, pyridine, ammonium hydroxide, tetra-alkylammonium salts such as tetramethylammonium hydroxide, tetraethyl-ammonium hydroxide, and the like. Typically, the neutralizing agent is dimethylethanolamine or alkali metal hydroxides, Most typically, the neutralizing agent is potassium hydroxide, In the case that a degree of neutralization of 100% is desired and. the salt forming group is an acid, an excess amount of base may be required to achieve a degree of neutralization of 100%.

Optionally, the pigment dispersion is further purified by an ultrafiltration step after step (c) or step (d). The ultrafiltration can be carried out on any conventional cross flow, hollow fiber membrane. Typically, the membrane has a fiber with inner diameter greater than 0.75 mm, more typically greater than 1 mm. Suitable commercially available materials for constructing the membrane include polyethylene, polypropylene, polysulfone, polyvinylidene fluoride, and ceramic.

During the ultrafiltration process, excess solvents, undesirable impurities and un-adsorbed dispersant polymer in the aqueous vehicle are removed by discontinuous, or more typically, continuous diafiltration with de-ionized water. Often the dispersion is diluted to less than 5% pigment concentration, more typically to less than 3% pigment concentration with &ionized water before diafiltration begins. After multiple volume dilutions, the dispersion is concentrated to greater than 10% pigment.

Fillers, plasticizers, pigments, carbon black, silica sols, other polymer dispersions and the known leveling agents, wetting agents, antifoaming agents, stabilizers, and other additives known for the desired end use, may also be incorporated into the dispersions.

### Ink Vehicle

The pigmented ink of this disclosure comprises an ink vehicle typically an aqueous ink vehicle, also known as an aqueous carrier medium, the aqueous dispersion and optionally other ingredients.

The ink vehicle is the liquid carrier (or medium) for the aqueous dispersion(s) and optional additives. The term “aqueous ink vehicle” refers to an ink vehicle comprised of water or a mixture of water and one or more organic, water-soluble vehicle components commonly referred to as co-solvents or humectants. Selection of a suitable mixture depends on requirements of the specific application, such as desired surface tension and viscosity, the selected pigment, drying time of the pigmented ink jet ink, and the type of paper onto which the ink will be printed. Sometimes in the art, when a co-solvent can assist in the penetration and drying of an ink on a printed substrate, it is referred to as a penetrant.

Examples of water-soluble organic solvents and humectaras include: alcohols, ketones, keto-alcohols, ethers and others, such as thioditzlycol, Sulfolane, 2-pyrrolidone, 1,3-dimethyl-2-imidazolidinone and caprolactam; tycols such as ethylene glycol, diethylene triethylene glycol, tetraethylene glycol, propylene glycol, dipropylene glycol, tripropylene glycol, trimethylene glycol, butylene glycol and hexylene glycol; addition polymers of oxyethylene or oxypropylene such as polyethylene glycol, polypropylene glycol and the like; triols such as glycerol and 1,2,6- hexanetriol; lower alkyl ethers of polyhydric alcohols, such as ethylene glycol monomethyl ether, ethylene glycol monoethyl ether, diethylene glycol monomethyl, diethylene glycol monoethyl ether; lower dialkyl ethers of polyhydric alcohols, such as diethylene glycol dimethyl or diethyl ether; urea and substituted ureas.

A mixture of water and a polyhydric alcohol, such as diethylene glycol, is typical as the aqueous ink vehicle. In the case of a mixture of water and diethylene glycol, the ink vehicle usually contains from 30% water and 70% diethylene glycol to 95% water and 5% diethylene glycol, more typically from 60% water and 40% diethylene glycol to 95% water and 5% diethylene glycol. Percentages are based on the total weight of the ink vehicle. A mixture of water and butyl carbitol is also an effective ink vehicle.

The amount of ink vehicle in the ink is typically in the range of from 70% to 99.8%, and more typically from 80% to 99.8%, by weight based on total weight of the ink.

The ink vehicle can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. Typical 1,2-alkanediols are C₄-C₆ alkanediols with 1,2-hexanediol being most typical. Suitable surfactants include ethoxylated acetylene diols (e.g. Surfynol® series commercially available from Air Products), ethoxylated alkyl primary alcohols (e.g. Neodol® series commercially available from Shell) and secondary alcohols (e.g. Tergitol® series commercially available from Union Carbide), sulfosuccinates (e.g. Aerosol® series commercially available from Cytec), omanosilicones (e.g. Silwett series commercially available from Witco) and fluoro surfactants (e.g. Zonyl® series commercially available from DuPont).

The amount of glycol ether(u)and 1,2-alkanediol(s) added is typically in the range of from 1% to 15%, and more typically from 2% to 10%, by weight based on the total weight of the ink. Surfactants may be used, typically in the amount of from 0.01% to 5% and more typically from 0.2% to 2%, by weight based on the total weight of the ink.

### Additives

Other ingredients, additives, may be formulated into the inkjet ink, to the extent that such other ingredients do not interfere with the stability and jetability of the inkjet ink. This may be readily determined by routine experimentation by one skilled in the art.

Surfactants are commonly added to inks to adjust surface tension and wetting properties. Suitable surfactants include the ones disclosed in the “vehicle” section above. Surfactants are typically used in amounts up to about 5% and more typically in amounts up to 2%, by weight based on the total weight of the ink.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylmetriamine-n,n,n′,n″,n″-pentaacetic acid (DTPA), and glycoletherdiamine-n,n,n′,n′-tetraacetic acid (GEDTA), and salts thereof, may be advantageous, for example, to eliminate deleterious effects of heavy metal impurities.

Polymers may be added to the ink to improve durability or other properties. The polymers can be soluble in the vehicle or in a dispersed form, and. can be ionic or non-ionic. Soluble polymers include linear homopolymers and copolymers or block polymers. They can also be structured polymers including graft or branched polymers, stars and dendrimers. The dispersed polymers may include, for example, latexes and hydrosols. The polymers may be made by any known process including, but not limited to, free radical, group transfer, ionic, condensation and other types of polymerization. The polymers may be made by a solution, emulsion, or suspension polymerization process. Preferred classes of polymer additives include anionic acrylic, styrene-acrylic and polyurethane polymer.

When a polymer is present, the polymer level is typically between about 0.01% and about 3%, by weight based on the total weight of an ink The upper limit is dictated by ink viscosity or other physical limitations.

Biocides may be used to inhibit growth of microorganisms.

Pigmented ink-jet inks typically have a surface tension in the range of about 20 mn·m⁻¹ to about 70 mn·m⁻¹, at 25° C. Viscosity can be as high as 30 mpa·s at 25° C., but is typically somewhat lower. The ink has physical properties compatible with a wick range of ejecting conditions, materials construction and the shape and size of the nozzle. The inks should have excellent storage stability for long periods so as not to clog to a significant extent in an ink-jet apparatus. Furthermore, the ink should not corrode parts of the ink-jet printing device it conies in contact with, and it should be essentially odorless and non-toxic.

Although not restricted to any particular viscosity range or printhead, the inks of the disclosure are particularly suited to lower viscosity applications, Thus the viscosity (at 25° C.) of the inks of this disclosure may be less than about 7 mPa·s, or less than about 5 mPa·s, and even more advantageously, less than about 3.5 mPa·s. The following examples illustrate specific embodiments of the present disclosure without, however, being limited thereto.

### EXAMPLES

Standard laboratory techniques for handling water sensitive chemicals were employed for the following examples. For example, glassware was extensively dried before use, monomers were stored over molecular sieves, and cannulation procedures were used to keep material dry.

Gel Permeation Chromatography (GPC) was uses to verify the predicted molecular weight and molecular weight distribution. The GPC system included a Waters 1515 Isocratic HPLC Pump, a Waters 2414 Refractive Index Detector, a Waters Autosampler, and a Waters Column Heater set at 40° C. and containing 4 Styregel columns (HR 0.5, HR 1, MR 2, and HR 4). Samples were eluted with THF at a flow rate of 1 mL/min. The samples were analyzed using Breeze 3.30 Software with a calibration curve developed from polymethylmethacate (PMMA) standards with narrow molecular weight range. Based on light scattering data provided by Polymer Laboratories Ltd., the nominal, peak molecular weight for the PMMA standards were as follows: 300000, 150000, 60000, 30000, 13000, 6000, 2000, and 1000.

### Particle Size Measurements

The particle size for the dispersions, pigments and the inks were determined by dynamic light scattering using a Microtrac® UPA 150 analyzer from Honeywell/Microtrac (Montgomeryville, Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to derive the particle size distribution. Results are reported as D50 or D95.

### Determination of Un-adsorbed Polymer

To determinate the un-adsorbed polymer in a dispersion, a sample of the dispersion is diluted with de-ionized water to the extent of having about 5% of colorant by weight. Typically, a 25 gram sample of this diluted dispersion is centrifuged at between 15,000 to 20,000 rpm for a period of 1-2 hours using a Beckman L-8 Ultracentrifuge. One skilled in the art can easily determine the optimal conditions for the centrifugation based on the properties of the dispersion. During centrifugation, the un-adsorbed dispersant polymer remains in the supernatant whereas the colorant, together with the adsorbed dispersant polymer on the colorant surface, deposits towards the bottom. After centrifugation, the supernatant is collected, and the amount of the un-adsorbed dispersant polymer in the supernatant is obtained by drying in an oven set at 150° C. for 3 hours, or until its weight becomes constant, to remove all volatiles, The percentage of un-adsorbed polymer is then calculated by dividing the weight of the un-adsorbed dispersant by the weight of colorant in the diluted sample subjected to centrifugation, Alternatively, the un--adsorbed polymer can be determined by centrifuging a dispersion in a similar manner followed by performing an HPLC analysis on the supernatant solution. Calibration of the HPLC is done by using known concentrations of the dispersant polymer.

### Polymer 1 (ETEGMA//BZMA//MAA 3.6//13.6//10.8)

To a 3-liter flask equipped with a mechanical stirrer, a thermometer, a N₂ inlet, a drying tube outlet and addition funnels were added THF (291.3 g) and catalyst tetrabutyl ammonium m-chloroberizoate (0.44 ml of a 1.0 M solution in acetonitrile). To the flask was injected an initiator 1,1-bis(trimethylsiloxy)-2-methyl propene (20.46 g, 0.0882 moles). Feed I containing tetrabutyl ammonium m-chlorobenzoate (0.33 ml of a 1.0 M solution in acetonitrile) and THF (16.92 g) was started and added over 185 minutes, Feed II containing trimethylsilyl methacrylate (152.00 g, 0.962 moles) was started at the same time when Feed I was started and added over 45 minutes. One hundred and eighty minutes after Feed II was completed (over 99% of the monomers had reacted), Feed III containing benzyl methacrylate (211.63 g, 1.20 moles) was started and added over 30 minutes. Forty minutes after Feed III was completed (over 99% of the monomers had reacted), Feed IV containing ethoxytriethyleneglycol methacrylate (78.9 g, 0.321 moles) was started and added over 30 minutes.

At 400 minutes since the start of Feed I, methanol (73.0 g) and 2-pyrrolidone (111.0 g) were added to the above solution and a distillation was initiated. During the first stage of distillation, 352.0 g of materials was removed. An additional amount of 2-pyrrolidone (340.3 g) was added, and another 81.0 g of materials was removed by distillation. To the remaining mixture was added 2-pyrrolidone (86.9 g) to give water-soluble Polymer 1.

This polymer had a composition of ETEGMA//BZMA//MAA 3.6//13.6//10.8 with a number average molecular weight (Mn) of 4,200 and an acid value of 2,90.

### Polymer 2 (BzMA/MAA 92/8)

The random linear water-insoluble Polymer 2 was prepared via group transfer polymerization (GTP)

To a 5-liter flask equipped with a mechanical stirrer, a thermometer, a N₂ inlet, a drying tube outlet and addition funnels were added THF (1684.1 g) and catalyst tetrabutyl ammonium m-chlorobenzoate (1.3 ml of a 1.0 M solution in acefonitrile). To the flask was injected an initiator 1-methoxy-1-trimethylsiloxy-2-methyl propene (73.26 g, 0.316 moles), Feed I containing tetrabutyl ammonium m-chlorobenzoate (1.1 ml of a 1.0 M solution in acetonitrile) and THF (10.5 g was started and added over 180 minutes. Feed II containing trimethylsilylmethacrylate (182.1 g, 1.15 moles) and benzyl methacrylate (BZMA, 1452.7 g, 8.25 moles) was started at the same time when Feed was started and added over 70 minutes, After monomer conversion was greater than 95%, methanol (94 g) was added to the reaction mixture and a distillation was initiated to remove the THF solvent. To the remaining mixture was added 2-pyrrolidone, in an amount equal to the THF removed, to provide Polymer 2 with 43.1% of solids.

The water insoluble Polymer 2 had a composition of BZMA/MAA 92/8 with a number average molecular weight (Mn) of 5,000 and an acid value of 0.949.

### Dispersion 1

To a stainless steel mixing vessel were added Polymer 1 (59,52 g of a 21.0 % solution which was pre-neutralized with sufficient KOH to a degree of neutralization of 90%), deionized water (274 g), methylethyl ketone (MEK, 157 0, and proxel (1.1 g). Mixing was conducted using a high speed dispersing (HSD) mixer initially set at approximately 500 rpm. During mixing, carbon black pigment (Nipex®180, 75 g) was added. slowly to allow sufficient time for wetting of the pigment. The pigment to dispersant ratio was 6:1. The speed of the END mixer was increased to 2000 rpm and maintained for 30 minutes. This was followed by milling in a microfluidizer at 10,000 psi for 12 passes. The methylethyl ketone solvent was removed from the pigment dispersion by a distillation at 65° C.-72° C. under vacuum.

### Control Dispersion 1A

To a stainless steel mixing vessel set at a speed of 1,000 rpm were added Polymer 1 (37.59 g of a 39.9% solution), KOH (4.70 g of an aqueous 45.5% solution for neutralizing Polymer 1 to a degree of neutralization of 90%), and deionized water (317.0 g). Mixing was continued at 2,000 rpm for 1 hour before carbon black pigment (Nipex® 180, 90 g) was added slowly to allow sufficient time for wetting of the pigment. The resulting pigment to dispersant ratio was 6:1. The speed of the HSD mixer was increased to 3000 rpm and maintained for 1 hour. To the mixture were added. an additional amount of deionized water (148.5 g) and Proxel (1.5 g). The premix thus obtained was then milled in a microfluidizer at 15,000 psi for 12 passes to provide control Dispersion IA made without the use of any methyl ethyl ketone solvent.

### Dispersion 2

To a stainless steel mixing vessel were added Polymer 1 (50.66 g of a 44.41% solution), KOH (7.05 g of a 45.5% aqueous solution sufficient for obtaining a degree of neutralization of 90% for Polymer 1), deionized water (207.78 g), methylethyl ketone (MEK, 94.5 g) and proxel (1.5 g). Mixing was conducted using a high speed dispersing (HSD) mixer initially set at approximately 500 rpm. During mixing, carbon black pigment (Nipex® 180, 90 g) was added slowly to allow sufficient time for wetting of the pigment. The pigment to dispersant ratio was 4:1. The speed of the HSD mixer was increased to 2000 rpm and maintained for 2 hours. To the mixture was added an additional amount of deionized water (148.5 g), This was followed by milling in a microfluidizer at 10,000 psi for 12 passes. The methylethyl ketone solvent was removed from the pigment dispersion by a distillation at 65° C.-72° C. under vacuum to provide Dispersion 2.

### Control Dispersion 2A

To a stainless steel mixing vessel set at a speed of 1,000 rpm were added Polymer 1 (56.39 g of a 39.9% solution), KOH (7.05 g of an aqueous 45.5% solution for neutralizing Polymer I to a degree of neutralization of 90%), and deionized water (296.56 g), Mixing was continued at 2,000 rpm for 1 hour before carbon black pigment (Nipex® 180, 90 g) was added slowly to allow sufficient time for wetting of the pigment. The resulting pigment to dispersant ratio was 4:1. The speed of the HSD mixer was increased to 3000 rpm and maintained for 1 hour. To the mixture were added an additional amount of deionized water (148.5 g) and Proxel (1.5 g). The premix thus obtained was then milled in a microfluidizer at 15,000 psi for 12 passes to provide control Dispersion 2A made without the use of any methyl ethyl ketone solvent,

### Comparative Dispersion 1

To a stainless steel mixing vessel were added Polymer 2 (34.80 g of a 43.1% solution), KOH (1.58 g of a 45,5% aqueous solution sufficient for obtaining a degree of neutralization of 90% for Polymer 2), deionized water (274.0 g), methylethyl ketone (MEK, 157.0 g) and proxel (1.1 g). Mixing was conducted using a high speed dispersing (HSD) mixer initially set at approximately 500 rpm. During mixing, carbon black pigment (Nipex® 180, 75 g) was added slowly to allow sufficient time for wetting of the pigment, The pigment to dispersant ratio was 5:1. The speed of the HSD mixer was increased to 2000 rpm, After 5 minutes of mixing at 2000 rpm, the premix thickened and gelled. Additional MEK and water were added to reduce the viscosity, but the premix remained gelled. This demonstrated that water-insoluble polymer can not be used as a dispersant in the instant inventive process.

### Dispersion 3

To a stainless steel mixing vessel were added Polymer 1 (50.66 g of a 4441% solution), KOH (13.75 g of a 45,5% aqueous solution sufficient for obtaining a degree of neutralization of 90% for Polymer 1), deionized water (318.4 g), acetone (63.0 g) and proxel (1.5 g). Mixing was conducted using a high speed dispersing (HSD) mixer initially set at approximately 500 rpm, During mixing, carbon black pigment (Nipex® 180, 90 g) was added slowly to allow sufficient time for wetting of the pigment. The pigment to dispersant ratio was 2:1. The speed. of the HSD mixer was increased to 2000 rpm and maintained for 1 hours. This was followed by milling in a microfluidizer at 10,000 psi for 12 passes. The acetone solvent was removed from the pigment dispersion by a distillation at 65° C.-7° C. under vacuum to provide Dispersion 3.

### Control Dispersion 3A

To a stainless steel mixing vessel set at a speed of 1,000 rpm were added Polymer 1 (112.78 g of a 39.9% solution), KOH (14.1 g of an aqueous 45.5% solution for neutralizing Polymer 1 to a degree of neutralization of 90%), and &ionized. water (233.11 g). Mixing was continued at 2,000 rpm for 1 hour before carbon black pigment (Nipex® 180, 90 g) was added slowly to allow sufficient time for wetting of the pigment. The resulting pigment to dispersant ratio was 2:1. The speed of the HSD mixer was increased to 3000 rpm and maintained for 1 hour. To the mixture were added an additional amount of &ionized water (148.5 g) and Proxel (1.5 g). The premix thus obtained was then milled in a microfluidizer at 15,000 psi for 12 passes to provide comparative Dispersion 3A made without the use of any methyl ethyl ketone solvent,

### Dispersion 4

To a stainless steel mixing vessel were added Polymer 1 (101.33 g of a 44.41% solution), KOH (14.1 g of a 45.5% aqueous solution sufficient for obtaining a degree of neutralization of 90% for Polymer 1), deionized water (298.57 g), methylethyl ketone (MEK, 94.5 g) and proxel (1.5 g). Mixing was conducted. using a high speed dispersing (USD) mixer initially set at approximately 500 rpm. During mixing, carbon black pigment (Nipex® 180, 90 g) was added slowly to allow sufficient time for wetting of the pigment. The pigment to dispersant ratio was 2:1. The speed of the HSD mixer was increased to 2000 rpm and maintained for 30 minutes. This was followed by milling in a microfluidizer at 10,000 psi for 12 passes. The methylethyl ketone solvent was removed. from the pigment dispersion by a distillation at 65° C.-72° C. under vacuum to provide Dispersion 4.

### Example 1

The initial particle sizes of Dispersion 1 and control Dispersion 1A were measured as well as the corresponding particle sizes after oven aging of the samples at 70° C. for 7 days. As shown in Table 1 below, Dispersion 1 showed no particle size growth whereas the control Dispersion 1A showed significant particle size growth.

TABLE 1

| | |
|---|---|
| | Particle Size |
| Initial Particle | After Aging |
| Size (nm) | for 7 Days (nm) |

| Dispersion | D50 | D95 | D50 | D95 |
|---|---|---|---|---|
| Dispersion 1 | 113 | 180 | 114 | 189 |
| Dispersion 1A | 96 | 166 | 142 | 757 |
| (control) | | | | |

### Example 2

The amount of un-adsorbed polymer, expressed as a percent of the total polymer present in the dispersion was measured for the inventive Dispersions 1-4 as well as control Dispersions 1A, 2A and 3A. As shown in Table 2, the inventive Dispersions 1 and 2, having relatively high pigment to dispersant polymer ratios, have significantly lower un-adsorbed polymer contents compared to the corresponding comparative Dispersions IA and 2A. Dispersions 3 and 4, having a lower pigment to dispersant ratio, also have lower un-adsorbed polymer contents when compared to the control Dispersion 3A, although not as significant as Dispersions 1 and 2.

TABLE 2

| | | | % Un-adsorbed |
|---|---|---|---|
| Dispersion | Milling Solvent | Pigment/Dispersant | Polymer |
| Dispersion 1 | MEK | 6:1 | 2.3 |
| Dispersion 1A | None | 6:1 | 51.0 |
| (control) | | | |
| Dispersion 2 | MEK | 4:1 | 11.0 |
| Dispersion 2A | None | 4:1 | 53.0 |
| (control) | | | |
| Dispersion 3 | Acetone | 2:1 | 45.0 |
| Dispersion 3A | None | 2:1 | 60.0 |
| (control) | | | |
| Dispersion 4 | MEK | 2:1 | 41.0 |

### Example 3

To test print durability of pigment dispersions made by the process of the present disclosure, Dispersion 2 and comparative Dispersion 2A were formulated into inks using an ink-jet vehicle targeting for a pigment concentration of 3%. Each ink was filled into a clean and empty HP51645A (Hewlett-Packard Co.) cartridge and printed on an HP870 printer (Hewlett-Packard Co.) on HP Brochure media. Durability was determined by smearing a yellow highlighter (Faber-Castell Textliner Highlighter—1548 refill) across a printed stripe, 60 minutes after being printed, one time, then immediately one more time on top of the first smear. As shown in Table 3, the ink made with Dispersion 2, using the instant inventive process, showed. only slight smear whereas the ink made with the control Dispersion 2A showed severe smear.

TABLE 3

| Dispersion in Ink | Highlighter Smear Rating* |
|---|---|
| Dispersion 2 | 4 |
| Dispersion 2A | 1 |
| (control) | |

*Visual Rating for Smear: (5 = best 0 = worst) 5 No smear visible 4 slight smear, narrow, doesn't run clear to next stripe 3 moderate smear, may be full width of highlighter, but light in color 2 noticeable smear, runs full width of area between stripes 1 severe smear, considerable color transfer, may be some damage to stripe 0 Ink largely removed from stripe with highlighter

What is claimed is:

1. A process for preparing an aqueous pigment dispersion comprising the steps of:
a) preparing an initial mixture comprising water, a pigment, an organic solvent and a water-soluble polymer as a dispersant to disperse said pigment, wherein said water-soluble polymer has a solubility of greater than 10 grams per 100 grams of water at 25° C., and said organic solvent is selected from the group consisting of methyl ethyl ketone, acetone, diethyl ketone, methyl isobutyl ketone, ethanol, isopropanol, dibutyl ether, tetrahydrofuran, and mixture thereof;
b) subjecting the initial mixture to a dispersive mixing operation;
c) milling to reduce particle size; and
d) removing said organic solvent.

2. The process of claim 1, wherein said water-soluble polymer contains a salt-forming group.

3. The process of claim 2, wherein said salt forming group is one or more members selected from the group consisting of —OH, —SH, —COOH, —COOH, —OPO₃H₂, —PO₃H₂, —SO₃H, —NR¹R², and mixture thereof, wherein each R¹ and R² are independently H, C₁-C₂₀ alkyl or C₇-C₂₀ aralkyl.

4. The process of claim 1, wherein said water-soluble polymer is an acrylic polymer.

5. The process of claim 1, wherein said water-soluble polymer is a polyurethane.

6. The process of claim 1, further comprising a step of purifying the dispersion by ultrafiltration after step (c) or step (d).

7. The process of claim 1, wherein step (d) comprises distillation to remove said organic solvent.

8. The process of claim 1, wherein step (d) comprises ultrafiltration to remove said. organic solvent.

9. The process of claim 1, wherein said organic solvent is methyl ethyl ketone.

10. The process of claim 1, wherein said organic solvent is isopropanol.

11. The process of claim 1, wherein said organic solvent is dibutyl ether.

12. The process of claim 3, wherein the degree of neutralization is in the range of 50% to 100%.

13. The process of claim 12, wherein the degree of neutralization is in the range of 70% to 95%.

14. The process of claim 3, wherein the ratio of said pigment to said water soluble polymer is from 10:1 to 1:1.

15. The process of claim 14, wherein the ratio of said pigment to said water soluble polymer is from 8:1 to 1:1.

16. The process of claim 1, wherein the average particle size after step is between 005 microns and 5 microns.

17. The process of claim 16, wherein the average particle size after step (c) is between 0.01 microns and 0.3 microns.
